(19) United States
(12) Patent Application Publication
(10) Pub. No.: US 2006/0002827 A1
(43) Pub. Date: Jan. 5, 2006

(54) Liquid reservoir connector

(76) Inventors: Mario Curcio, Sins (CH); Emad Sarofim, Zug (CH)

Correspondence Address: Roche Diagnostics Corporation, 9115 Hague Road, PO Box 50457, Indianapolis, IN, 46250-0457, US

(21) Appl. No.: 11/168,695

(22) Filed: Jun. 28, 2005

(30) Foreign Application Priority Data
Jul. 3, 2004 (EP) EP 04 015 700.0

(51) Int. Cl. B01L 11/00

(52) U.S. Cl. 422/103

(57) ABSTRACT

A device and method for interconnecting at least one reservoir for holding at least one liquid with at least one area in or on a test element to be supplied and/or brought into contact with the liquid is provided. In accordance with one embodiment, the reservoir and the area to be supplied and/or brought into contact with the liquid are integrated on the same test element or are arranged on separate embodiments. The device comprises at least one capillary-like tube or conduit comprising an inlet and an outlet at opposite ends thereof, which tube or conduit is at least along a section at least nearly rigid.

### BACKGROUND OF THE INVENTION

The present invention relates to the field of in vitro diagnostics and, more particularly, to a liquid reservoir connector.

Robustness and simplicity are the keys of a good IVD (in vitro diagnostics) test. Sometimes, robust assays based on reliable chemistry and detection are not simple because of, for example, the number of steps required, the level of manual operation and the need for skilled hands. Sample volumes and analysis time are other important issues. Reducing the scale of the test, bringing it into a disposable, e.g., by using microfluidics, where all chemical steps are integrated, makes it simpler and faster, thus nearer to the patient. However, the robustness can be compromised.

Although the chemistry of a disposable test format is the same as with a conventional laboratory test, the mode of reaction is indeed different, i.e., dry chemistry versus wet homogeneous chemistry. In most cases, the conditions should be changed. Sometimes the test itself should be changed, which can require significant R&D effort. The general problem is a low degree of freedom in choosing assay and detection format, limited by geometry, volumes, surfaces, dissolving and diffusion rates, mixing efficiency, chemical stability and cost of manufacturing. Sometimes it would be just useful, other times necessary, to include also a washing or dilution step or to have a ready-to-use reagent separately stored in solution. The possibility to have liquid reservoirs integrated onto disposable test elements can certainly help reduce the R&D effort.

At present there are not many examples of integrated and simply actuated microcontainers which allow storage of liquids. One particular known case is represented by a calibration solution pouch integrated into i-STAT cartridges. Actuation consists in applying external pressure puncturing the pouch against a barb. Other known microfluidic devices are capable of combining discrete fluid volumes. Certain embodiments utilize adjacent chambers divided by a rupture region such as a frangible seal, others utilize deformable membranes and/or porous regions to direct fluid flow. Actuation can be pneumatically or magnetically assisted. In still another example, devices and methods are described for storing and moving liquids by means of complex manufacture comprising quills or laminar, preformed or transfer sheets, requiring also complex actuation. In yet another example of a liquid container, a deformable blister sealed by a membrane is described, which is rupturable by a spike shaped in the wall of the blister itself, allowing the reagent and/or carrier liquid to contact an absorbent strip and run along it. Yet still other examples of integrated blisters exist.

### SUMMARY OF THE INVENTION

It is against the above background that the present invention provides certain unobvious advantages and advancements over the prior art. In particular, the inventors have recognized a need for improvements in liquid reservoir connector design.

Although the present invention is not limited to specific advantages or functionality, it is noted that the present invention provides a further simple means to obtain a connection between a liquid reservoir, e.g., a storing chamber or a fluidic channel, with a further area or location in or on a test element on or into which the liquid or fluid can be applied, which area can be brought into contact with the liquid or fluid.

In accordance with one embodiment of the present invention, a device for interconnecting at least one reservoir for holding at least one liquid with at least one area in or on a test element to be supplied and/or brought into contact with the liquid is provided, wherein the reservoir and the area to be supplied and/or brought into contact with the liquid are integrated on the same test element or are arranged on separate embodiments, and the device comprises at least one capillary-like tube or conduit comprising an inlet and an outlet at opposite ends thereof, which tube or conduit is at least along a section at least nearly rigid.

In accordance with another embodiment of the present invention, a method of interconnecting at least one reservoir for holding at least one liquid with an area in or on a test element to be supplied and/or brought into contact with the liquid is provided comprising: providing a capillary-like tube or conduit comprising an inlet and an outlet at opposite ends thereof and puncturing or piercing the reservoir and the test element such that the liquid can flow or penetrate through the device from the reservoir to the area to be supplied and/or brought into contact with the liquid. Openings or ports are arranged at the reservoir and at the area, each closed by a septum or closing membrane.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIGS. 1a-1c show schematically the general mechanism for interconnecting a liquid reservoir to a fluidic part or detection zone situated on the same test element and/or on different embodiments in accordance with an embodiment of the present invention;

FIGS. 2a and 2b show the use of an external hollow staple rising from a staple cartridge to connect the liquid reservoir to the fluidic part or detection zone in accordance with an embodiment of the present invention;

FIGS. 3a-3c show further designs of an inventive device in accordance with one or more embodiments of the present invention;

FIGS. 4a-4d show possible two-dimensional arrays of device bridges arranged on carrying supports in accordance with one or more embodiments of the present invention;

FIGS. 5a-5c show connector devices consisting of a channel drawn in an external plastic plate in accordance with one or more embodiments of the present invention;

FIG. 6 shows schematically the use of a two-dimensional array of device bridges to interconnect various liquid reservoirs to a plurality of fluidic tubes in accordance with an embodiment of the present invention; and

FIGS. 7a-7d show one method to obtain arrayed structures such those in FIGS. 2, 4a and 4d, during mass production, in accordance with one or more embodiments of the present invention.

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiment(s) of the present invention.

### DETAILED DESCRIPTION OF THE INVENTION

The present invention, in accordance with at least one embodiment, refers to a simple but efficient way of storing liquids within disposable devices by keeping them entirely separated from a fluidic channel and chemistry and/or a sample holding chamber contained therein until a connection is established by means of an external device, which can have beside a connecting function also a chemical/biological reactive or separating function.

In accordance with an embodiment of the present invention, the liquid, whatever its function will be, can be integrated on the same or similar disposable, typically a microfluidic device, and can achieve also plurality, either parallel, sequential or combinatorial, all at the disposable level and for microscale applications.

In accordance with an embodiment of the present invention, it is possible to integrate in a cost effective way a liquid reservoir onto a disposable such as, e.g., an analytical test device, by eliminating the intermediate need to integrate also a valve. The container or sample holding chamber is kept physically separated from the fluidic part or from another container or chamber, respectively. In this way, a set of containers and channels can be simply manufactured on the same disposable or analytical element with any desired geometry, or even on separate embodiments. Connection between reservoirs and from reservoirs to channels or e.g., sample holding chambers, is then established by means of devices as those proposed below comprising external capillary-like tubes or conduits, individual or arrayed in different possible ways, and exercising possibly also other functions apart from a connecting function, e.g., chemical/biological reactive or separating function.

In accordance with an embodiment of the present invention, the device comprises at least one capillary-like tube or conduit, which can be preshaped and/or hollow, being along at least a section at least nearly rigid, for interconnecting at least one reservoir, e.g., a liquid storing chamber, a liquid transporting channel or a liquid transporting tube, with at least one area to be supplied and/or brought into contact with the liquid or fluid. The liquid and the area to be supplied are typically in or on the same disposable or test element, but can be also in or on two separate assemblies or bodies.

By using the present device, in accordance with at least one embodiment, an opening or port at a container or channel, being closed by means of a septum, membrane or other impermeable sealing layer, can be punctured or pierced by the rigid one end of the device, which means of the preshaped capillary-like tube or conduit. Another container or another part on a disposable, e.g., to be supplied with the liquid, can be punctured or pierced by the other end of the capillary-like tube or conduit, which can also comprise a rigid or hard nozzle-like end, to interconnect the two containers or areas for transporting the liquid or to supply the liquid from one location to the other. The capillary-like tube or conduit and the rigid ends may be manufactured of a rigid or semi-flexible polymer, such as, e.g., a polyolefin, PEEK (Polyetheretherketone), PVC (Polyvinylchloride), polyamide or the like, of a metal, as e.g., steel or titanium, or glass, as e.g., fused silica, externally coated and eventually internally coated. Typically, the capillary-like tube or conduit is comprising at both ends a rigid nozzle or small orifice.

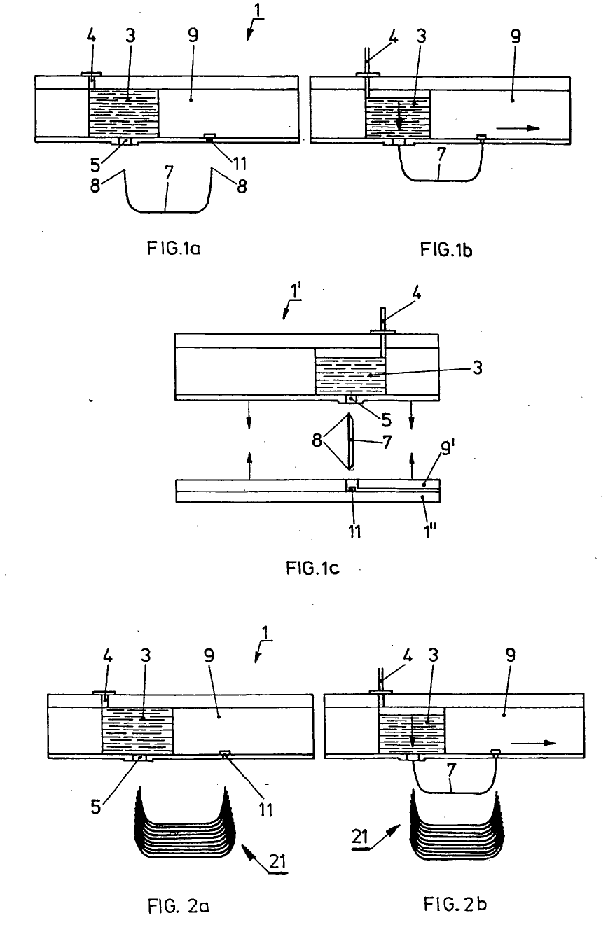

In accordance with one embodiment, the use of a bridge device is illustrated in FIG. 1 a+b, where test element 1 is containing a liquid storage reservoir 3 and a testing area 9 which can be supplied with the liquid out of the storage reservoir 3. In FIG. 1a the test element 1 is shown in its initial non-used stage and in FIG. 1b in the situation of use.

In accordance with the instant embodiment, for interconnecting the liquid storage reservoir 3 with the testing area 9 a device 7 or instrument is used, which can be U-shaped and which can have rigid open ends 8. This connecting or bridge device 7 can be punched through a septum or membrane 5 and at the same time through a closing membrane or septum 11.

As one can see very clearly in FIG. 1b, the liquid out of the storage reservoir 3 due to a vent opening 4 or pressure application through the opening 4, can penetrate through the device 7 into the testing area 9 where a testing procedure, e.g., using the liquid, can be executed.

In principle, the device 7 may have any shape. Instead of U shape as shown in FIG. 1 a+b, e.g., a straight linear shape, as shown in FIG. 1c, is only one further possibility.

Within the example as shown in FIG. 1c, a storage reservoir 3 is included within a liquid storage element 1′, which storage element can be moved in the direction of the indicated arrows towards a test element 1″ on which e.g., an analytical element 9′ is arranged. Again, by using a device 7 with rigid open ends 8 on one side the septum or membrane 5 at the storage reservoir 3 and on the other side another membrane at the liquid introduction zone (closing membrane or septum) 11 arranged within the analytical test element 9′ are punctured.

The device 7, which can comprise a capillary-like conduit, could play also an active role in this procedure besides the passive connecting role. For example, a catalytic conversion or an enzymatic reaction having as substrate an analyte contained within the stored liquid, e.g., a reference standard, could be carried out during the passage through the device 7 if this is properly functionalized. In another example, the same device 7 could be used for clean up, e.g., removal of buffering salt, of a sample contained within the stabilized liquid, or even for separation of analytes by capillary electrophoresis or chromatographic methods.

If a plurality of testing elements 1 have to be actuated, which means have to be supplied with interconnecting devices 7, a stack of devices 7, e.g., arranged like staples in a staple magazine or cartridge, may be used as shown in FIGS. 2a and 2b.

From a stack of devices 7 stored in a staple-like cartridge, a single device 7 can be separated with a stapler-like mechanism and connect the liquid reservoir 3 to the testing area 9 of the test element by puncturing the septa or closing membranes 5 and 11, respectively. The interconnecting device 7, which can be capillary tube-like, may be disposed together with the testing element after use.

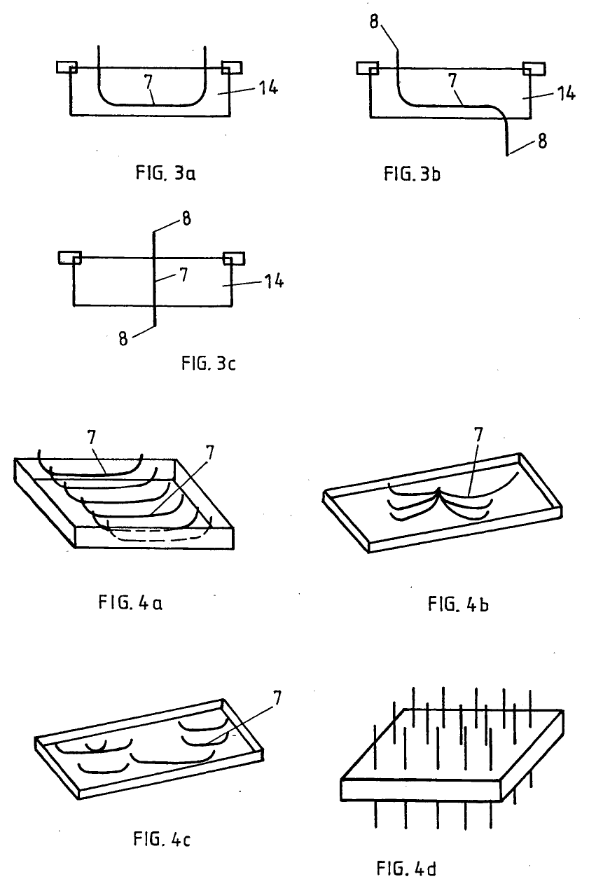

In FIGS. 3a-3c, further possible designs or embodiments of an interconnecting device 7 are shown, with the capillary conduit arranged within a support frame 14 for better handling.

In FIGS. 4a to 4d, two-dimensional arrays of bridges or devices 7 are shown which can be arranged e.g., in parallel as shown or in sequence, for interconnecting reservoirs to individual channels or multiple channels and/or different reservoirs for liquid mixing and carrying out reactions in any possible combinations.

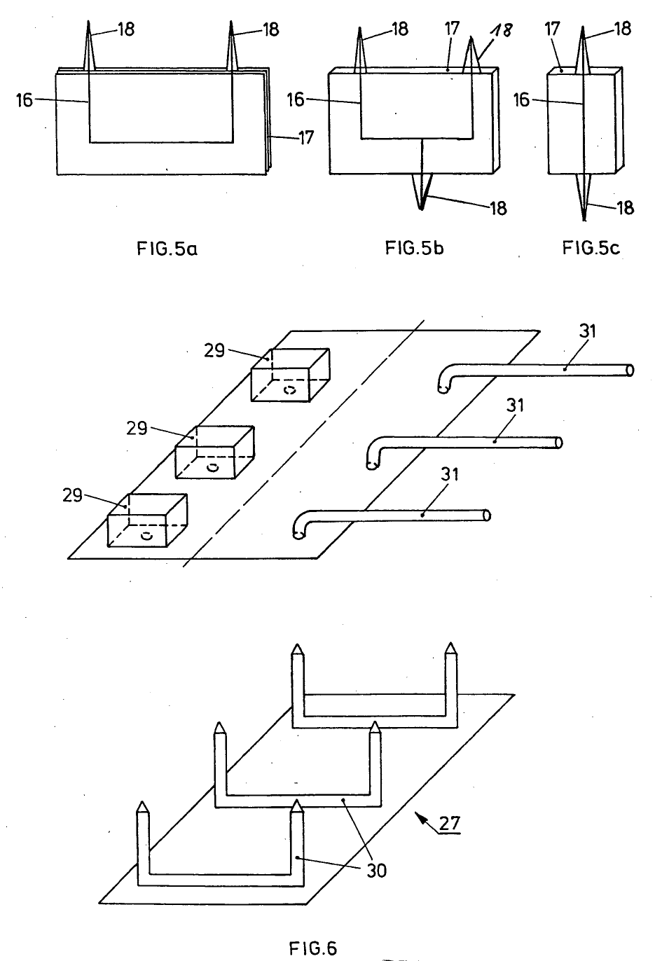

FIGS. 5 a-c again show different designs or embodiments of inventive coupling devices, the interconnecting conduit 16 being micro-machined within rigid plates 17, as e.g., plates made out of a polymer. Two protruding barbs 18 at the extremities of the conduit 16 are typical to puncture the septa as explained with reference to FIGS. 1 and 2. Again, only some examples are shown, as different geometries with different orientations of the extremities are possible.

FIG. 6 shows a two-dimensional array 27 of individual connectors or conduits 30, provided for interconnecting a plurality of liquid reservoirs 29 with respective liquid channels or tubes 31. By using the arrangement 27, a plurality of liquid chambers can be interconnected to the respective tubes 31 simultaneously, and therefore at the same time e.g., a plurality of testing procedures can be executed.

The various designs, arrays, applications or embodiments of the present invention are only used as examples for better describing thereof. Another feature refers to the materials to be used. Again, the material to be chosen is e.g., dependent on the application, which means is dependent upon the liquid to be transported through the capillary-like conduit and on the function of this, passive or active. Fused silica is in this context a typical substrate for chemical derivatization, while some metals are known to have inerent catalytic properties and are good heat conductors. It could be indeed that the capillary-like conduit is to be exposed to heat for a certain reaction to occur within it. In other cases, inert materials are instead typical. In general, one can choose from a range of polymers such as polyolefins, PEEK, polyamide, and PVC, which are sufficiently rigid or semi-rigid. Metal can be, for example, iron, steel or titanium. Fused silica capillaries like those used for capillary electrophoresis can be also employed.

Another feature refers to an equipment for applying the inventive devices or instruments individually to interconnect liquid chambers to e.g., a testing element. As shown with reference to FIG. 2, the devices can be stored in a stack 21 which can be arranged similar to the so-called Bostitch® fastening clips, where typically a number of 50 or 100 are arranged in line, one clip abutting to the next one, for example. Similar to the mentioned Bostitch® fastening clips also the proposed inventive capillary-like conduits can be arranged and be punched individually for the various testing pads, where a testing or analytical area has to be supplied with a liquid, arranged in a liquid chamber on the same disposable.

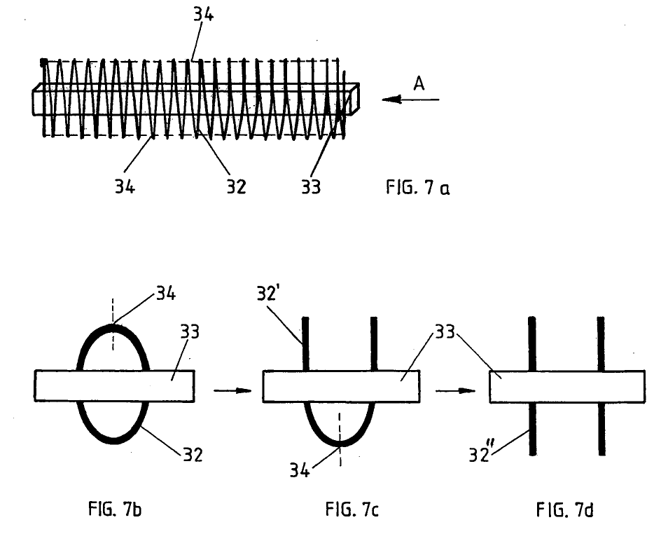

In FIGS. 7 a-d, in accordance with another embodiment of the present invention, a method is schematically suggested for mass production of device arrays, especially in parallel arrangement, as schematically shown in FIGS. 2, 4a, 4d and 6, characterized in that a long capillary-like tube or conduit is coiled in the shape of a spring 32, eventually functionalized in this shape for active function described above, encased within a support frame or plate 33, and subsequently cut longitudinally along one or two exposed axis 34 in order to create a series of U-shaped, or straight equal-sized devices with open ends.

In FIG. 7b, the structure of FIG. 7a is seen in direction of the arrow A, which means the spring or coil 32 not being cut along the axis 34.

In FIG. 7c, the coil or spring 32 of the structure according to FIG. 7a is cut along the upper axis 34, so that U-shaped elements 32′ will be created, arranged one U-shaped element in parallel behind the other one.

If the coil or spring 32 is cut along both axes 34 then straight-lined elements 32″ will be created in a parallel arrangement as very similar is schematically shown in FIG. 4d.

Of course within FIGS. 7a-7d only one method is suggested for the production of arrays of inventive elements and it is of course possible to use other methods.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A device for interconnecting at least one reservoir for holding at least one liquid with at least one area in or on a test element to be supplied and/or brought into contact with the liquid, wherein
the reservoir and the area to be supplied and/or brought into contact with the liquid are integrated on the same test element or are arranged on separate embodiments and
the device comprises at least one capillary-like tube or conduit comprising an inlet and an outlet at opposite ends thereof, which tube or conduit is at least along a section at least nearly rigid.

2. The device of claim 1, wherein the capillary-like tube or conduit is preshaped.

3. The device of claim 1, wherein the capillary-like tube or conduit is hollow.

4. The device of claim 1, wherein the inlet and/or the outlet comprise an orifice-like nozzle.

5. The device of claim 1, wherein the inlet and/or the outlet are capable of puncturing or piercing a membrane or septum.

6. The device of claim 1, wherein at least one section of the capillary-like tube or conduit comprises a material selected from a polymer, metal, glass or combination thereof.

7. The device of claim 6, wherein the polymer is selected from polyolefin, polyetheretherketone, polyvinyl chloride, polyamide, or combinations thereof.

8. The device of claim 6, wherein the metal is selected from iron, steel or titanium.

9. The device of claim 6, wherein the glass is fused silica.

10. The device of claim 6, wherein the material is semi-flexible or rigid.

11. The device of claim 1, wherein the capillary-like tube or conduit comprises at least one open-end section.

12. The device of claim 11, wherein the open-end section comprises a material selected from a polymer, metal, glass or combination thereof.

13. The device of claim 12, wherein the material is semi-flexible or rigid.

14. The device of claim 1, wherein the device is stacked within a cartridge or stack-like array.

15. The device of claim 1, wherein the device is arranged on or within a frame or support plate.

16. The device of claim 1, wherein the capillary-like tube or conduit is arranged in a coil.

17. The device of claim 1, wherein the capillary-like tube or conduit is substantially U-shaped.

18. The device of claim 1, wherein the capillary-like tube or conduit is substantially straight.

19. The device of claim 1 comprising a plurality of capillary-like tubes or conduits of substantially equal size.

20. An arrangement for interconnecting a plurality of reservoirs for holding at least one liquid with areas to be supplied and/or brought into contact with the liquid or liquids, respectively, wherein on or within a support frame or support plate in the sense of an array a plurality of devices according to claim 1 are arranged.

21. A method of interconnecting at least one reservoir for holding at least one liquid with an area in or on a test element to be supplied and/or brought into contact with the liquid comprising:
providing a capillary-like tube or conduit comprising an inlet and an outlet at opposite ends thereof and
puncturing or piercing the reservoir and the test element such that the liquid can flow or penetrate through the device from the reservoir to the area to be supplied and/or brought into contact with the liquid, and wherein
openings or ports are arranged at the reservoir and at the area, each closed by a septum or closing membrane.

22. The method of claim 21, wherein the inlet and/or the outlet comprise a rigid orifice-like nozzle.

23. The method of claim 21, wherein the capillary-like tube or conduit is arranged in a coil, and further comprising cutting the tube or conduit longitudinally along one or two exposed axis.
